(19) United States
(12) Patent Application Publication
(10) Pub. No.: US 2026/0301096 A1
(43) Pub. Date: Oct. 1, 2026

(54) MULTI AGENT COMPUTER SYSTEM FOR GENERATING CUSTOMIZED ELECTRONIC DOCUMENTS

(71) Applicant: U STARTUPS INC., Bethesda, MD (US)

(72) Inventors: John JABARA, Bethesda, MD (US); Marc STEREN, Bethesda, MD (US); Khuram ZAMAN, Bethesda, MD (US)

(73) Assignee: U STARTUPS INC., Bethesda, MD (US)

(21) Appl. No.: 19/629,782

(22) Filed: Mar. 26, 2026

Related U.S. Application Data
(60) Provisional application No. 63/779,153, filed on Mar. 27, 2025.

(51) Int. Cl. G06Q 50/20; G06F 40/284; G06F 40/58; G06V 30/19

(52) U.S. Cl. CPC G06Q 50/2057; G06F 40/284; G06F 40/58; G06V 30/19

(57) ABSTRACT

Systems and methods for generating disability-customized transition plans from electronic documents are disclosed. A system can receive electronic input comprising user-specific educational records and user context data via a network interface. The system can execute a natural language processing model to extract structured features comprising at least one post-secondary aspiration, at least one academic performance indicator, and at least one disability-related support need. The system can map each structured feature to a predefined transition planning category. The system can encode a state object representation for the user comprising the structured features, one or more candidate careers, and one or more candidate accommodations. The system can execute specialized artificial intelligence agents as nodes in a directed processing graph, comprising a goal planning agent, a career matching agent, and an accommodation agent. The system can customize a structured electronic transition plan formatted in an accessibility-adapted representation.

### CROSS REFERENCE TO RELATED APPLICATIONS

This application claims priority to U.S. Provisional Patent Application No. 63/779,153, filed Mar. 27, 2025, which is incorporated herein by reference in its entirety for all purposes.

### BACKGROUND

The Individuals with Disabilities Education Act (IDEA) in the United States, and analogous frameworks in other jurisdictions, require individualized transition planning to support learners with disabilities as they move toward post-secondary education, employment, and independent living. Today this planning is largely performed manually by educators and counselors who must review heterogeneous educational records (e.g., IEPs, progress reports, vocational assessments, teacher notes, and student work artifacts) in multiple formats (PDF, scanned images, free-form text). They then synthesize this information into a structured plan that addresses post-secondary aspirations, current performance, disability-related needs, and required supports. Existing software typically offers static forms or basic rules-based checklists; these systems do not automatically extract structured features from unstructured documents, do not encode a machine-readable state representation of the learner, and rarely integrate advanced natural language processing or machine-learning models to generate individualized transition goals, match users to appropriate careers and accommodations, or ensure completeness with respect to legal transition-planning requirements.

Conventional AI-assisted tools that operate over text generally rely on a single monolithic model that produces free-form summaries or responses without a directed orchestration of specialized components, without a defined internal state object, and without technical guardrails tailored to sensitive educational data. Such systems typically lack mechanisms to (i) map extracted information into predefined transition-planning categories such as post-secondary vision, disability-related needs, community experiences, and action steps; (ii) apply machine-enforced safety rules such as PII detection and redaction, disability-sensitive language enforcement, and age-appropriate content filtering; (iii) select jurisdiction-specific rules and career datasets based on a country identifier; and (iv) output accessibility-adapted representations suitable for users with diverse disabilities and assistive technologies. There is therefore a need for improved computer-implemented systems and methods that transform heterogeneous educational records into a structured state object, orchestrate multiple specialized AI agents through a directed processing graph to generate transition goals, candidate careers, and accommodations, enforce safety and compliance constraints, and produce a disability-customized transition plan in a structured electronic format.

### SUMMARY

For the aforementioned reasons, what is needed is a computer-implemented system and method that automatically ingests heterogeneous educational records, extracts and encodes structured user features into a machine-readable state representation, orchestrates multiple specialized AI components through a directed processing pipeline to generate transition goals, career matches, and accommodations under machine-enforced safety and compliance rules, and outputs an accessibility-adapted, disability-customized transition plan in a structured electronic format.

The methods and systems discussed herein relate to a computer-implemented transition planning platform that transforms heterogeneous educational records and user context data into a structured, disability-customized transition plan using a coordinated set of software modules and artificial-intelligence components. In various implementations, a transition planning recommendation system receives, over a network, electronic input including user-specific educational records (such as IEPs, progress reports, vocational assessments, teacher notes, and student work artifacts) and user context data (including a country identifier, preferred language, age group, and optionally disclosed disability information). A document ingestion pipeline, which may include optical character recognition and a natural language processing (NLP) model, processes the educational records to extract structured features such as post-secondary aspirations, academic performance indicators, and disability-related support needs. These structured features are mapped into predefined transition-planning categories, for example post-secondary vision, disability-related needs, community experiences, and action steps, and encoded into a machine-readable state object representation that functions as a centralized data structure for downstream processing.

The methods and systems discussed herein further employ an AI orchestration and recommendation module that executes a plurality of specialized artificial-intelligence agents arranged as nodes in a directed processing graph. Using the state object as input, a goal-planning agent generates measurable transition goals, a career-matching agent queries a country-specific career data store to identify compatible careers, and an accommodation agent retrieves recommended educational and workplace accommodations from an accommodation knowledge base. In some implementations, a guardrail enforcement engine applies machine-enforced safety rules to inputs and outputs of the agents, including detection and redaction of personally identifiable information using an entity-recognition model, enforcement of disability-sensitive language using a stored lexicon and sentiment-based thresholds, and age-appropriate content filtering based on the user's age group. A compliance module may validate the generated goals and accommodations against jurisdiction-specific transition-planning rules selected based on the country identifier. A transition plan generation and accessibility/localization module then assembles a structured electronic transition plan that includes the transition goals, candidate careers, and accommodations organized by transition-planning category and renders the plan in an accessibility-adapted representation, such as simplified language, semantic markup suitable for assistive technologies, and text-to-speech compatible content, optionally localized to the user's preferred language.

The methods and systems discussed herein provide several technical advantages over conventional computer-implemented educational planning tools. First, they introduce a document ingestion and natural language processing pipeline that transforms heterogeneous, partially unstructured educational records into a normalized, machine-readable state object. By combining optical character recognition, NLP-based feature extraction, and explicit mapping into predefined transition-planning categories, the system enables downstream components to operate on structured data rather than free-form text. This improves computational efficiency, supports deterministic routing of information to specialized modules, and facilitates consistent storage and retrieval of user profiles and transition plans in data repositories.

Second, the methods and systems discussed herein implement a multi-agent AI orchestration architecture in which specialized artificial-intelligence agents (including at least a goal-planning agent, a career-matching agent, and an accommodation agent) are executed as nodes in a directed processing graph over the shared state object. This design improves modularity and scalability relative to monolithic models by allowing each agent to be independently configured, updated, and optimized for its specific computational task, while preserving a coherent state across the pipeline. Third, the integration of a guardrail enforcement engine and jurisdiction-specific validation module provides a technical mechanism for enforcing machine-readable safety and compliance policies-such as entity-recognition-based PII redaction, lexicon-driven disability-sensitive language filtering, age-based content constraints, and rule-based detection of missing transition-planning elements-directly within the data processing flow. Finally, the transition plan generation and accessibility/localization module produces accessibility-adapted, structured electronic representations that are automatically formatted for assistive technologies and language localization, thereby enabling client devices to render consistent, machine-interpretable transition plans without requiring bespoke post-processing on each endpoint.

In one embodiment, the techniques described herein relate to a method for generating a disability-customized transition plan from electronic documents for a user, the method including: receiving, by one or more processors via a network interface, electronic input including (i) user-specific educational records including at least one of an individualized education program (IEP), progress report, vocational assessment, teacher notes, or student work artifact, and (ii) user context data including at least a country identifier, preferred language, age group, and any voluntarily disclosed disability information; executing, by the one or more processors, a feature extraction engine comprising a natural language processing (NLP) model to extract a plurality of structured features including at least one post-secondary aspiration, at least one academic performance indicator, and at least one disability-related support need; mapping, by the one or more processors, each structured feature to a predefined transition planning category selected from post-secondary vision, disability-related needs, community experiences, and action steps; encoding, by the one or more processors, a machine-readable state object representation for the user that includes at least the plurality of structured features, one or more candidate careers, and one or more candidate accommodations; executing, by the one or more processors using an orchestration engine and based on the machine-readable state object representation, a plurality of specialized artificial intelligence agents invoked as nodes in a directed processing graph, the plurality of specialized artificial intelligence agents including at least: a goal planning agent configured to process the machine-readable state object representation and generate, using a generative artificial intelligence model, a plurality of transition goals formatted as measurable objectives and organized according to the predefined transition planning category, a career matching agent configured to process the machine-readable state object representation and query a country-specific career data store based on the country identifier to identify the one or more candidate careers compatible with mapped structured features, and an accommodation agent configured to process the machine-readable state object representation and retrieve, from an accommodation knowledge base, the one or more candidate accommodations associated with at least one of the at least one disability-related support need and the one or more candidate careers; and generating, by the one or more processors, a structured electronic transition plan for the user including the plurality of transition goals, the one or more candidate careers, and the one or more candidate accommodations organized according to the predefined transition planning category and formatted in an accessibility-adapted representation selected based on the user context data, the accessibility-adapted representation including at least one of simplified language, semantic markup for assistive technologies, or text-to-speech compatible content.

In some aspects, the techniques described herein relate to a method, further including, for each invocation of a respective specialized artificial intelligence agent: applying, by a guardrail enforcement engine executed by the one or more processors, a set of machine-enforced safety rules to at least one of an input to and an output from the respective specialized artificial intelligence agent, the set of machine-enforced safety rules including at least: detecting and redacting personally identifiable information using an entity-recognition model, enforcing disability-sensitive language by replacing prohibited terms with preferred alternatives according to a stored lexicon and rejecting outputs that violate a sentiment-based threshold for negative framing, and enforcing age-appropriate content constraints based on the age group in the user context data.

In some aspects, the techniques described herein relate to a method, further including: validating, by the one or more processors, the plurality of transition goals and the one or more candidate accommodations against a set of stored jurisdiction-specific transition planning rules selected based on the country identifier, validating including automatically detecting absence of at least one required transition-planning element and, in response, causing the goal planning agent to regenerate or augment at least a portion of the plurality of transition goals.

In some aspects, the techniques described herein relate to a method, wherein executing the NLP model further includes performing optical character recognition (OCR) on at least one user-specific educational record received as an image or scanned document to convert the image or scanned document into machine-readable text prior to extracting the plurality of structured features.

In some aspects, the techniques described herein relate to a method, wherein encoding the state object representation for the user further includes including, in the state object representation, at least one inferred limitation selected from a literacy challenge, numeracy challenge, or social communication need based on analysis of the user-specific educational records, and receiving, via a user interface and from a human reviewer, a confirmation or modification of the at least one inferred limitation.

In some aspects, the techniques described herein relate to a method, wherein the career matching agent is further configured to determine the one or more candidate careers by applying at least one machine learning technique selected from a classification model that predicts likely career paths from labeled training data, a clustering model that groups users according to similarity metrics and selects careers associated with each group, a collaborative filtering model that recommends careers selected by users with similar state object representations, and a reinforcement learning model that updates career recommendations based on feedback from counselors.

In some aspects, the techniques described herein relate to a method, wherein customizing the structured electronic transition plan further includes selecting, by the one or more processors, at least one accessibility parameter from a group consisting of font size, contrast mode, text complexity level, and text-to-speech playback speed, and generating the accessibility-adapted representation according to the at least one selected accessibility parameter.

In some aspects, the techniques described herein relate to a method, further including generating, by a translation module executed by the one or more processors, a localized version of the structured electronic transition plan in the preferred language, wherein generating the localized version includes translating text content and adapting at least one career-related term based on country-specific terminology associated with the country identifier.

In some aspects, the techniques described herein relate to a method, wherein the state object representation further includes a session identifier and a conversation history, and wherein executing the plurality of specialized artificial intelligence agents as nodes in the directed processing graph includes persisting updates to the state object representation after execution of each specialized artificial intelligence agent to enable resumption of the generation of the disability customized transition plan in response to an interruption.

In another embodiment, the techniques described herein relate to a non-transitory computer readable medium for generating a disability-customized transition plan from electronic documents, the non-transitory computer readable medium including instructions, that when executed, cause at least one processor to: receive, via a network interface, electronic input including (i) user-specific educational records including at least one of an individualized education program (IEP), progress report, vocational assessment, teacher notes, or student work artifact, and (ii) user context data including at least a country identifier, preferred language, age group, and any voluntarily disclosed disability information; execute a feature extraction engine comprising a natural language processing (NLP) model to extract a plurality of structured features including at least one post-secondary aspiration, at least one academic performance indicator, and at least one disability-related support need; map each structured feature to a predefined transition planning category selected from post-secondary vision, disability-related needs, community experiences, and action steps; encode a machine-readable state object representation for the user that includes at least the plurality of structured features, one or more candidate careers, and one or more candidate accommodations; execute, using an orchestration engine and based on the state object representation, a plurality of specialized artificial intelligence agents invoked as nodes in a directed processing graph, the plurality of specialized artificial intelligence agents including at least: a goal planning agent configured to process the machine-readable state object representation and generate, using a generative artificial intelligence model, a plurality of transition goals formatted as measurable objectives and organized according to the predefined transition planning category, a career matching agent configured to process the machine-readable state object representation and query a country-specific career data store based on the country identifier to identify the one or more candidate careers compatible with mapped structured features, and an accommodation agent configured to process the machine-readable state object representation and retrieve, from an accommodation knowledge base, the one or more candidate accommodations associated with at least one of the at least one disability-related support need and the one or more candidate careers; and generate a structured electronic transition plan for the user including the plurality of transition goals, the one or more candidate careers, and the one or more candidate accommodations organized according to the predefined transition planning category and formatted in an accessibility-adapted representation selected based on the user context data, the accessibility-adapted representation including at least one of simplified language, semantic markup for assistive technologies, or text-to-speech compatible content.

In some aspects, the techniques described herein relate to a non-transitory computer readable medium, wherein the instructions further cause the at least one processor to: for each invocation of a respective specialized artificial intelligence agent: applying, by a guardrail enforcement engine executed by the one or more processors, a set of machine-enforced safety rules to at least one of an input to and an output from the respective specialized artificial intelligence agent, the set of machine-enforced safety rules including at least: detecting and redacting personally identifiable information using an entity-recognition model, enforcing disability-sensitive language by replacing prohibited terms with preferred alternatives according to a stored lexicon and rejecting outputs that violate a sentiment-based threshold for negative framing, and enforcing age-appropriate content constraints based on the age group in the user context data.

In some aspects, the techniques described herein relate to a non-transitory computer readable medium, wherein the instructions further cause the at least one processor to: validate the plurality of transition goals and the one or more candidate accommodations against a set of stored jurisdiction-specific transition planning rules selected based on the country identifier, validating including automatically detecting absence of at least one required transition-planning element and, in response, causing the goal planning agent to regenerate or augment at least a portion of the plurality of transition goals.

In some aspects, the techniques described herein relate to a non-transitory computer readable medium, wherein executing the NLP model further includes performing optical character recognition (OCR) on at least one user-specific educational record received as an image or scanned document to convert the image or scanned document into machine-readable text prior to extracting the plurality of structured features.

In some aspects, the techniques described herein relate to a non-transitory computer readable medium, wherein encoding the state object representation for the user further includes including, in the state object representation, at least one inferred limitation selected from a literacy challenge, numeracy challenge, or social communication need based on analysis of the user-specific educational records, and receiving, via a user interface and from a human reviewer, a confirmation or modification of the at least one inferred limitation.

In some aspects, the techniques described herein relate to a non-transitory computer readable medium, wherein the career matching agent is further configured to determine the one or more candidate careers by applying at least one machine learning technique selected from a classification model that predicts likely career paths from labeled training data, a clustering model that groups users according to similarity metrics and selects careers associated with each group, a collaborative filtering model that recommends careers selected by users with similar state object representations, and a reinforcement learning model that updates career recommendations based on feedback from counselors.

In some aspects, the techniques described herein relate to a non-transitory computer readable medium, wherein customizing the structured electronic transition plan further includes selecting, by the one or more processors, at least one accessibility parameter from a group consisting of font size, contrast mode, text complexity level, and text-to-speech playback speed, and generating the accessibility-adapted representation according to the at least one selected accessibility parameter.

In some aspects, the techniques described herein relate to a non-transitory computer readable medium, wherein the instructions further cause the at least one processor to: generate, by a translation module executed by the at least one processor, a localized version of the structured electronic transition plan in the preferred language, wherein generating the localized version includes translating text content and adapting at least one career-related term based on country-specific terminology associated with the country identifier.

In some aspects, the techniques described herein relate to a non-transitory computer readable medium, wherein the state object representation further includes a session identifier and a conversation history, and wherein executing the plurality of specialized artificial intelligence agents as nodes in the directed processing graph includes persisting updates to the state object representation after execution of each specialized artificial intelligence agent to enable resumption of the generation of the disability customized transition plan in response to an interruption.

In yet another embodiment, the techniques described herein relate to a computer system including at least one processor configured to: receive, via a network interface, electronic input including (i) user-specific educational records including at least one of an individualized education program (IEP), progress report, vocational assessment, teacher notes, or student work artifact, and (ii) user context data including at least a country identifier, preferred language, age group, and any voluntarily disclosed disability information; execute a feature extraction engine comprising a natural language processing (NLP) model to extract a plurality of structured features including at least one post-secondary aspiration, at least one academic performance indicator, and at least one disability-related support need; map each structured feature to a predefined transition planning category selected from post-secondary vision, disability-related needs, community experiences, and action steps; encode a machine-readable state object representation for the user that includes at least the plurality of structured features, one or more candidate careers, and one or more candidate accommodations; execute, using an orchestration engine and based on the machine-readable state object representation, a plurality of specialized artificial intelligence agents invoked as nodes in a directed processing graph, the plurality of specialized artificial intelligence agents including at least: a goal planning agent configured to process the machine-readable state object representation and generate, using a generative artificial intelligence model, a plurality of transition goals formatted as measurable objectives and organized according to the predefined transition planning category, a career matching agent configured to process the machine-readable state object representation and query a country-specific career data store based on the country identifier to identify the one or more candidate careers compatible with mapped structured features, and an accommodation agent configured to process the machine-readable state object representation and retrieve, from an accommodation knowledge base, the one or more candidate accommodations associated with at least one of the at least one disability-related support need and the one or more candidate careers; and generate a structured electronic transition plan for the user including the plurality of transition goals, the one or more candidate careers, and the one or more candidate accommodations organized according to the predefined transition planning category and formatted in an accessibility-adapted representation selected based on the user context data, the accessibility-adapted representation including at least one of simplified language, semantic markup for assistive technologies, or text-to-speech compatible content.

In some aspects, the techniques described herein relate to a computer system claim 19, wherein the at least one processor is further configured to, for each invocation of a respective specialized artificial intelligence agent: applying, by a guardrail enforcement engine executed by the one or more processors, a set of machine-enforced safety rules to at least one of an input to and an output from the respective specialized artificial intelligence agent, the set of machine-enforced safety rules including at least: detecting and redacting personally identifiable information using an entity-recognition model, enforcing disability-sensitive language by replacing prohibited terms with preferred alternatives according to a stored lexicon and rejecting outputs that violate a sentiment-based threshold for negative framing, and enforcing age-appropriate content constraints based on the age group in the user context data.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing. In the drawings:

FIG. 1 is a schematic block diagram of a transition plan recommendation system communicating with user devices, a server, a data repository, and a machine learning model over a network;

FIG. 2A is a flow chart illustrating an example method for generating a structured user state for transition planning based on educational records and user context data; and

FIG. 2B is a flow chart illustrating a process for generating specialized-agent outputs and customizing an accessibility-adapted electronic transition plan.

### DETAILED DESCRIPTION

Below are detailed descriptions of various concepts related to, and approaches, methods, apparatuses, and systems for implementing the various techniques described herein. The various concepts introduced above and discussed in greater detail below may be implemented in any of numerous ways, as the described concepts are not limited to any particular manner of implementation. Examples of specific implementations and applications are provided primarily for illustrative purposes.

Transition planning for students with disabilities is a required component of special education services under federal law, establishing a structured approach for the student's progression from secondary education to post-secondary activities such as higher education, vocational training, employment, and independent living. Under the Individuals with Disabilities Education Act (IDEA), students with disabilities must have a transition plan integrated into their Individualized Education Program (IEP) before reaching the age of sixteen, with some states requiring earlier implementation. Transition plans must be tailored to the student's unique interests, preferences, strengths, and needs, such that the student can receive appropriate support for achieving post-secondary goals. The preparation of transition plans requires the aggregation and analysis of extensive documentation, including past assessments, progress reports, teacher observations, and stakeholder input from parents, educators, and vocational specialists. Given the volume of information involved, the manual review and drafting process can be time-consuming and can rely heavily on specialized knowledge of laws, educational strategies, and community resources.

However, despite legal requirements, studies indicate that only approximately fifty percent of IEPs include a transition plan, and many of the transition plans that do exist fail to comprehensively incorporate student aspirations, career readiness, and life skills development. Conventional transition planning methods typically involve paper-based records, fragmented digital files, and inefficient manual processes, such that educators and administrators face challenges in developing effective, personalized transition plans at scale. The heavy reliance on the subjective knowledge and understanding of the reviewers introduces variability in how transition plans are formulated and executed. A nationwide shortage of trained special education professionals' results in transition planning being conducted by individuals with limited expertise in the nuanced regulatory and developmental aspects of special education. The lack of standardized methodologies and automated tools to synthesize and interpret student data introduces inconsistencies in plan quality, reduces compliance with IDEA requirements, and can lead to suboptimal post-secondary outcomes for students.

The techniques described herein can address the limitations of manual transition planning by employing artificial intelligence models to automate the extraction, categorization, and generation of structured transition plan components. A natural language processing model can receive electronic inputs comprising individualized education programs, progress reports, vocational assessments, and related documents, such that structured features such as post-secondary aspirations, academic performance indicators, and disability-related support needs can be extracted from the electronic inputs. A document processing engine incorporating optical character recognition can digitize scanned or handwritten materials, converting the materials into machine-readable text for downstream processing. A student profile analyzer can consolidate the extracted features, mapping the extracted features to predefined transition planning categories such as post-secondary vision, disability-related needs, community experiences, and action steps. A recommendation engine employing generative artificial intelligence can process a machine-readable state object representation of the student to generate personalized transition goals, career matches, and accommodation recommendations organized according to regulatory requirements.

To implement the techniques described herein, a system can receive user-specific educational records and user context data via a network interface. The system can execute a natural language processing model to extract structured features from the user-specific educational records. The system can map each structured feature to a predefined transition planning category. The system can encode a machine-readable state object representation for the user that includes the structured features, one or more candidate careers, and one or more candidate accommodations. The system can execute a plurality of specialized artificial intelligence agents invoked as nodes in a directed processing graph. The plurality of specialized artificial intelligence agents can include a goal planning agent that can generate a plurality of transition goals formatted as measurable objectives, a career matching agent that can query a country-specific career data store to identify the one or more candidate careers, and an accommodation agent that can retrieve the one or more candidate accommodations from an accommodation knowledge base. The system can customize a structured electronic transition plan for the user comprising the plurality of transition goals, the one or more candidate careers, and the one or more candidate accommodations organized according to the predefined transition planning category and formatted in an accessibility-adapted representation.

In doing so, the techniques described herein can streamline the transition planning process by reducing the manual effort required by educators and special education professionals. The techniques described herein can enhance the accuracy and completeness of transition plans by automating the extraction and categorization of relevant information from diverse document formats. The techniques described herein can improve post-secondary success rates for students with disabilities by generating individualized transition plans that are data-driven and customized to support the unique needs of each student. The techniques described herein can further customize the generated transition plan in accessibility-adapted formats, including simplified language, semantic markup for assistive technologies, or text-to-speech compatible content, based on voluntarily disclosed disability information and user preferences, such that the transition plan can be more readily accessed and understood by disabled users. The techniques described herein can provide a technical improvement over existing approaches by generating training datasets that result in improved downstream performance of various machine learning models without requiring application-specific loss function or architecture modifications.

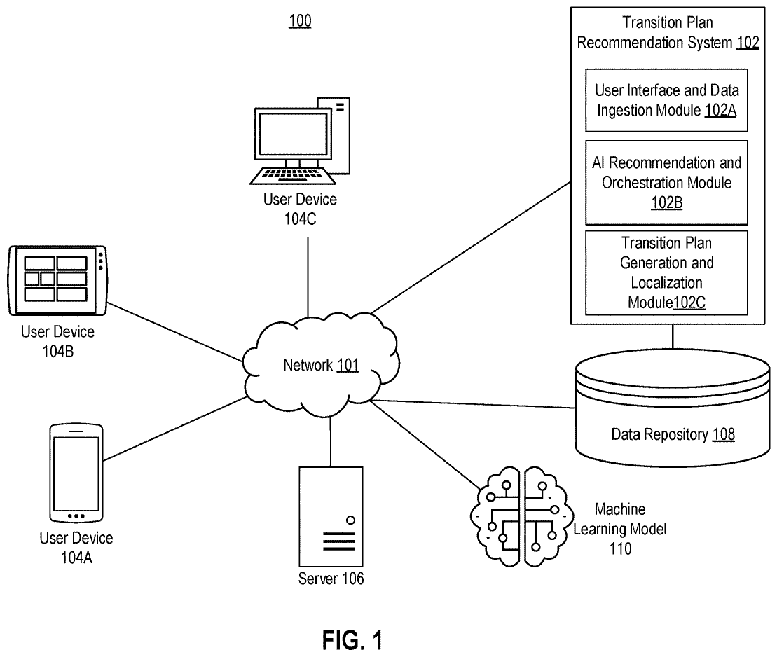

Referring now to FIG. 1, illustrated is a block diagram of a system environment 100 for generating disability-customized transition plans from electronic educational records. The system environment 100 can include a transition plan recommendation system 102, a network 101, one or more user devices 104A-104C, a server 106, a data repository 108, and a machine learning model 110. The transition plan recommendation system 102 can include a user interface and data ingestion module 102A, an AI recommendation and orchestration module 102B, and a transition plan generation and localization module 102C.

The system environment 100 can include at least one transition plan recommendation system 102. The transition plan recommendation system 102 can be a computing platform that automates the generation of structured transition plans for students with disabilities by processing educational records and user context data. The transition plan recommendation system 102 can execute a feature extraction engine comprising a natural language processing model to extract post-secondary aspirations, academic performance indicators, and disability-related support needs from user-specific educational records. The transition plan recommendation system 102 can receive electronic input comprising individualized education programs, progress reports, vocational assessments, teacher notes, or student work artifacts via a network interface, and can execute a plurality of specialized artificial intelligence agents to generate a plurality of transition goals, identify candidate careers, and retrieve candidate accommodations. For example, the transition plan recommendation system 102 can receive an individualized education program document that includes a statement indicating the student aspires to pursue a career in culinary arts, a progress report documenting the student's reading level at a ninth-grade equivalent, and teacher notes describing the student's need for text-to-speech software for written assignments, and can execute a goal planning agent to generate a transition goal formatted as “By June 2026, the student will complete a vocational cooking course at a community college as measured by course completion certificate,” a career matching agent to identify candidate careers such as “sous chef” or “food service manager” based on the expressed interest in culinary arts, and an accommodation agent to retrieve candidate accommodations such as “text-to-speech software for recipe reading” or “extended time for written menu planning assignments” based on the documented reading level and assistive technology needs. The transition plan recommendation system 102 may store processor-executable instructions in non-transitory memory, which can be accessed and executed by one or more processors to implement operations for transition plan generation. The instructions may include instructions to process optical character recognition on scanned documents, execute machine-learning models for feature extraction, generate transition goals using generative artificial intelligence, and format outputs in accessibility-adapted representations.

The transition plan recommendation system 102 can include a user interface and data ingestion module 102A. The user interface and data ingestion module 102A can be a software component that receives electronic input comprising user-specific educational records and user context data via a network interface. For example, the user interface and data ingestion module 102A can receive an individualized education program document, a progress report in portable document format, a vocational assessment spreadsheet, teacher notes in word processing document format, or a student work artifact such as a digital portfolio image uploaded by an educator, parent, or administrator through a web-based interface or a mobile application. The user interface and data ingestion module 102A can receive user context data including at least a country identifier, preferred language, age group, and any voluntarily disclosed disability information. In some implementations, the user interface and data ingestion module 102A can receive scanned documents or images captured via a mobile or tablet application, which can be processed using an optical character recognition engine to convert handwritten or printed text into machine-readable text.

For example, the user interface and data ingestion module 102A can receive a scanned teacher note containing handwritten observations regarding a student's academic strengths and behavioral patterns, and the optical character recognition engine can convert the handwritten text into a machine-readable text string such as “Student demonstrates strong verbal communication skills but requires additional support for written assignments,” which can be processed by downstream components for feature extraction and transition plan generation. The user interface and data ingestion module 102A may transmit the received electronic input to the AI recommendation and orchestration module 102B via internal communication channels or application programming interfaces. The transmission may include data formatted as structured records or serialized objects that can be processed by downstream components for feature extraction and transition plan generation.

The transition plan recommendation system 102 can include an AI recommendation and orchestration module 102B. The AI recommendation and orchestration module 102B can be a software component that executes a feature extraction engine comprising a natural language processing model to extract structured features from user-specific educational records and orchestrates a plurality of specialized artificial intelligence agents to generate transition plan components. For example, the AI recommendation and orchestration module 102B can receive an individualized education program document that includes a statement indicating the student aspires to pursue a career in culinary arts, a progress report documenting the student's reading level at a ninth-grade equivalent, and teacher notes describing the student's need for text-to-speech software for written assignments, and can execute the natural language processing model to extract a post-secondary aspiration such as “pursue a career in culinary arts,” an academic performance indicator such as “reading level at ninth-grade equivalent,” and a disability-related support need such as “requires text-to-speech software for written assignments.”

The AI recommendation and orchestration module 102B can map each extracted structured feature to a predefined transition planning category, such that the post-secondary aspiration is mapped to the post-secondary vision category, the academic performance indicator is mapped to the action steps category, and the disability-related support need is mapped to the disability-related needs category. The AI recommendation and orchestration module 102B can encode a machine-readable state object representation for the user that comprises at least the plurality of structured features, one or more candidate careers, and one or more candidate accommodations. In some implementations, the AI recommendation and orchestration module 102B can execute a plurality of specialized artificial intelligence agents invoked as nodes in a directed processing graph, the plurality of specialized artificial intelligence agents comprising at least a goal planning agent, a career matching agent, and an accommodation agent.

For example, the AI recommendation and orchestration module 102B can execute the goal planning agent to process the machine-readable state object representation and generate, using a generative artificial intelligence model comprising one or more transformer layers and one or more convolutional layers, a plurality of transition goals formatted as measurable objectives such as “By June 2026, the student will complete a vocational cooking course at a community college as measured by course completion certificate,” can execute the career matching agent to process the state object representation and query a country-specific career data store based on the country identifier to identify one or more candidate careers such as “sous chef” or “food service manager” that are compatible with the mapped structured features, and can execute the accommodation agent to process the state object representation and retrieve, from an accommodation knowledge base, one or more candidate accommodations such as “text-to-speech software for recipe reading” or “extended time for written menu planning assignments” that are associated with the disability-related support need and the candidate careers.

The AI recommendation and orchestration module 102B may apply a set of machine-enforced safety rules to at least one of an input to and an output from each specialized artificial intelligence agent, the set of machine-enforced safety rules comprising detecting and redacting personally identifiable information, enforcing disability-sensitive language, and enforcing age-appropriate content constraints. The application of safety rules may include replacing prohibited terms with preferred alternatives according to a stored lexicon and rejecting outputs that violate a sentiment-based threshold for negative framing to comply with disability-sensitive language requirements, such that a generated transition goal that includes the phrase “student is confined to a wheelchair” is replaced with “student uses a wheelchair” prior to inclusion in the structured electronic transition plan.

In some embodiments, the plurality of specialized artificial intelligence agents further comprises at least one of a skills assessment agent, a knowledge retrieval agent, a conversational routing agent, and a translation agent. A skills assessment agent can generate interactive assessment items, receive user responses, and update the state object representation with inferred skill levels and gap analyses relative to target careers or transition goals. A knowledge retrieval agent can perform retrieval-augmented generation by executing semantic search queries over curated document corpora, retrieving factual passages concerning at least one of regulatory requirements, program descriptions, or local service providers, and providing the retrieved passages as conditioning context to a language model used by the other agents.

The conversational routing agent can inspect the state object representation, including conversation history and user profile fields, and determine which subset of specialized artificial intelligence agents to invoke next by evaluating routing conditions defined in the directed processing graph. The translation agent can transform internally generated text in a canonical language into the preferred language indicated in the user context data, applying terminology mappings and handling right-to-left or left-to-right rendering differences, and may be invoked as a node in the directed processing graph prior to execution of the transition plan generation and localization module 102C. In some implementations, the state object representation further includes fields such as a guardrail flag, a current agent identifier, and a routing history list, which are updated after each agent invocation to enable deterministic, stateful execution of the directed processing graph.

In some implementations, a guardrail enforcement engine operates at multiple boundaries of the directed processing graph, including an input layer, an inter-agent layer, and an output layer. At the input layer, the guardrail enforcement engine may perform input sanitization and prompt injection detection by applying pattern-matching rules and classifier-based models to identify and block adversarial instructions or inputs exceeding configured length or complexity thresholds. At the inter-agent layer, the guardrail enforcement engine may validate that agent outputs conform to expected schemas, prevent unauthorized propagation of personally identifiable information between agents, and check guardrail flags in the state object representation before allowing downstream agents to execute. At the output layer, the guardrail enforcement engine may perform hallucination checks on factual claims by cross-referencing agent outputs against one or more knowledge bases, may log redacted versions of inputs and outputs to an audit log with associated metadata, and may update bias or safety metrics based on observed interactions.

In certain embodiments, if the guardrail enforcement engine detects outputs that cannot be automatically corrected, such as repeated unverifiable factual claims or indications of user distress in natural language input, it sets one or more escalation flags in the state object representation and causes the transition plan recommendation system 102 to route the session to a human reviewer or to restrict further automated agent actions for that session.

In some implementations, the AI recommendation and orchestration module 102B operates in accordance with a “Disability Filter=Success Filter” design principle, in which disability-related information is processed as a positive signal for identifying success-enabling support rather than as a basis for restricting opportunities. The transition plan recommendation system 102 may maintain a plurality of predefined disability categories, such as autism spectrum disorder, specific learning disability, emotional disturbance, intellectual disability, speech or language impairment, orthopedic impairment, visual impairment, hearing impairment, and other health impairment. When the user context data or previously ingested records indicate that the user belongs to one or more of these categories, a conversational agent or specialized dialog component of the AI recommendation and orchestration module 102B can present conditional follow-up questions specific to the identified categories. These questions can elicit nuanced needs such as sensory sensitivities, executive functioning challenges, communication preferences, or social interaction supports.

Responses to such conditional follow-up questions may be parsed by the natural language processing model and stored as additional fields in the state object representation, including structured descriptors of needs (for example, “noise sensitivity,” “difficulty with multi-step instructions,” or “benefits from visual schedules”) and preferred support modalities (for example, “checklists,” “noise-reducing headphones,” or “visual timers”). In some embodiments, the AI recommendation and orchestration module 102B accesses a disability-skills matrix that maps combinations of disability category and identified need to transition-planning outputs including one or more of: (i) annual transition activities, (ii) key supports and accommodations, and (iii) recommended support services. The disability-skills matrix can be implemented as a table or rule set associating each condition (for example, [autism spectrum disorder, sensory sensitivity]) with specific activities (for example, “practice using noise-cancelling devices in community settings”), supports (for example, “access to a quiet workspace”), and services (for example, “occupational therapy consultation”), which are then used by the goal planning agent and accommodation agent to populate candidate goals and accommodations in the state object.

The transition plan recommendation system 102 can include a transition plan generation and localization module 102C. The transition plan generation and localization module 102C can be a software component that receives structured data from the AI recommendation and orchestration module 102B and generates a formatted electronic transition plan document organized according to predefined transition planning categories. For example, the transition plan generation and localization module 102C can receive a plurality of transition goals generated by the goal planning agent, one or more candidate careers identified by the career matching agent, and one or more candidate accommodations retrieved by the accommodation agent, and can organize the received data into sections corresponding to post-secondary vision, disability-related needs, community experiences, and action steps. In some implementations, the transition plan generation and localization module 102C can apply accessibility formatting rules based on user context data to generate an accessibility-adapted representation of the structured electronic transition plan.

For example, the transition plan generation and localization module 102C can select simplified language formatting for users in the K-12 age group, semantic markup formatting compatible with screen reader software for users who voluntarily disclosed visual impairments, or text-to-speech compatible content formatting for users who voluntarily disclosed dyslexia. The transition plan generation and localization module 102C can select at least one accessibility parameter from a group consisting of font size, contrast mode, text complexity level, and text-to-speech playback speed based on the user context data and can apply the at least one selected accessibility parameter to the formatted electronic transition plan document.

In some implementations, the transition plan generation and localization module 102C can generate a localized version of the structured electronic transition plan by translating text content from a source language to a preferred language specified in the user context data. For example, the transition plan generation and localization module 102C can translate a transition goal formatted in English as “By June 2026, the student will complete a vocational cooking course at a community college as measured by course completion certificate” into Arabic as “ [symbol] 2026 [symbol] [symbol] [symbol] ” and can adapt at least one career-related term such as “community college” to a country-specific equivalent term such as “ [symbol] ” for Saudi Arabia or “ [symbol] ” for Kuwait. The translation operations may include querying a stored terminology database that maps career-related terms to country-specific equivalents based on the country identifier, or executing a machine translation model trained on career-related corpora that includes examples of occupation titles, educational institution types, and vocational training programs in multiple languages. The transition plan generation and localization module 102C can format the structured electronic transition plan in a plurality of export formats comprising at least one of a portable document format, word processing document format, or hypertext markup language format. The formatting operations may include applying document templates that define page layout parameters such as margin width, line spacing, and font family, inserting section headers corresponding to the predefined transition planning categories, and embedding metadata fields that identify the user identifier, country identifier, and generation timestamp associated with the structured electronic transition plan. In some implementations, the transition plan generation and localization module 102C can transmit the formatted electronic transition plan document to one or more user devices 104A-104C via the network 101 for presentation to educators, parents, or administrators.

The system environment 100 can include a network 101. The network 101 can be a communication infrastructure that couples the transition plan recommendation system 102, the one or more user devices 104A-104C, the server 106, the data repository 108, and the machine learning model 110 to enable data transmission and exchange among the components. For example, the network 101 can be the Internet, a local area network, a wide area network, a cellular network, or any combination thereof, and can facilitate transmission protocols such as hypertext transfer protocol, transmission control protocol, or user datagram protocol. The network 101 can transmit electronic input comprising user-specific educational records and user context data from the one or more user devices 104A-104C to the transition plan recommendation system 102.

In some implementations, the network 101 can transmit structured electronic transition plans generated by the transition plan recommendation system 102 to the one or more user devices 104A-104C for presentation to educators, parents, or administrators. The network 101 may transmit requests for data retrieval or storage between the transition plan recommendation system 102 and the data repository 108 or may transmit requests for machine learning model inference between the transition plan recommendation system 102 and the machine learning model 110. The transmission may include encrypted data packets formatted according to transport layer security protocols or other secure communication standards to protect user privacy and comply with data protection regulations such as the Family Educational Rights and Privacy Act or state-specific data privacy laws.

In some embodiments, the transition plan recommendation system 102 establishes a persistent bidirectional communication channel, such as a WebSocket connection, between the server 106 and one or more user devices 104A-104C. As the AI recommendation and orchestration module 102B executes the directed processing graph, it may generate progress events indicating internal processing milestones, such as “starting goal planning agent,” “querying occupation knowledge base,” or “identified eight college recommendations.” These progress events are transmitted over the WebSocket connection to the frontend interface, enabling real-time feedback that the system is actively processing the user's input and providing transparency into the multi-stage computation pipeline.

The system environment 100 can include one or more user devices 104A-104C. The one or more user devices 104A-104C can be computing devices operated by educators, parents, students, administrators, therapists, vocational counselors, or school psychologists to interact with the transition plan recommendation system 102 via the network 101. For example, the one or more user devices 104A-104C can be desktop computers, laptop computers, tablet computers, or smartphones capable of executing a web browser application or a mobile application to access the user interface and data ingestion module 102A. The one or more user devices 104A-104C can transmit the electronic input comprising the user-specific educational records and the user context data to the transition plan recommendation system 102 via the network 101.

In some implementations, the one or more user devices 104A-104C can receive the structured electronic transition plan from the transition plan recommendation system 102 and can present the structured electronic transition plan via a graphical user interface for review, modification, or distribution to stakeholders. The one or more user devices 104A-104C may execute local processing operations such as optical character recognition on scanned documents or images captured via a camera or may upload the scanned documents or images to the transition plan recommendation system 102 for remote processing by the document processing engine. In some implementations, the one or more user devices 104A-104C can validate input data formats prior to transmission, such as by confirming that uploaded files conform to supported file types selected from portable document format, word processing document format, or image formats such as joint photographic experts' group or portable network graphics. The one or more user devices 104A-104C may compress files for efficient transmission over the network 101 or may cache frequently accessed data such as previously uploaded individualized education program documents or user context data to reduce network latency and improve responsiveness during subsequent interactions with the transition plan recommendation system 102.

The system environment 100 can include a server 106. The server 106 can be a computing platform that hosts at least one component selected from the transition plan recommendation system 102, the data repository 108, or the machine learning model 110, or that provides one or more auxiliary services selected from user authentication, session management, load balancing, or content delivery. For example, the server 106 can be a cloud-based virtual machine instance executing on infrastructure provided by Amazon Web Services, Microsoft Azure, or Google Cloud Platform, a physical rack-mounted server located in a data center operated by an educational institution or government agency, or a containerized application deployed on a distributed orchestration platform such as Kubernetes or Docker Swarm. The server 106 can execute processor-executable instructions stored in non-transitory memory to implement operations for transition plan generation, the operations including receiving electronic input via the network 101, executing the natural language processing model to extract structured features from user-specific educational records, orchestrating the plurality of specialized artificial intelligence agents invoked as nodes in the directed processing graph, and formatting the structured electronic transition plan in the accessibility-adapted representation.

In some implementations, the server 106 can transmit requests to the data repository 108 to retrieve at least one data element selected from user-specific educational records, country-specific career records, or accommodation knowledge base records, or to store at least one data element selected from state object representations or generated transition plans. The server 106 may transmit requests to the machine learning model 110 to execute inference operations for at least one task selected from extracting structured features from user-specific educational records, generating transition goals formatted as measurable objectives, or identifying candidate careers compatible with mapped structured features, or may retrieve pre-trained model parameters from the machine learning model 110 for local execution on one or more processors coupled to the server 106. The communication between the server 106 and the data repository 108 or the machine learning model 110 may include application programming interface calls formatted according to representational state transfer principles, remote procedure call protocols, or message queue protocols to enable interoperability between distributed components deployed across geographically separated data centers or cloud regions.

In some embodiments, the transition plan recommendation system 102 is deployed in a multi-region configuration in which separate instances of the data repository 108 and associated services are provisioned for different jurisdictions, and the country identifier in the user context data determines which regional instance is used for storage and processing. Access control policies may restrict each regional instance to only process data associated with its assigned country identifier, thereby enforcing per-country data residency and enabling the system to apply jurisdiction-specific guardrail and transition-planning rule sets without cross-border data transfer.

The system environment 100 can include a data repository 108. The data repository 108 can be a data storage system that maintains user-specific educational records, country-specific career data, accommodation knowledge base records, and generated transition plans, such that the transition plan recommendation system 102 can retrieve educational records, career records, or accommodation records to extract structured features, identify candidate careers, and retrieve candidate accommodations during transition plan generation. For example, the data repository 108 can be a relational database management system such as PostgreSQL, a NoSQL database such as MongoDB, a distributed file system such as Apache Hadoop Distributed File System, or a cloud-based object storage service such as Amazon Simple Storage Service. The data repository 108 can store user context data including country identifiers, preferred languages, age groups, and voluntarily disclosed disability information in structured data tables or document collections.

In some implementations, the data repository 108 can store a country-specific career data store that comprises a plurality of career records each including occupation classifications corresponding to labor market data for at least one of the United States, Saudi Arabia, or Kuwait. For example, the data repository 108 can store a career record for the occupation title “information technology specialist” that includes a Standard Occupational Classification code of 15-1251, a median annual wage of $97,430 for the United States labor market, a job growth projection of 13 percent from 2020 to 2030, and an educational requirement of a bachelor's degree, such that the career matching agent (a part of the AI recommendation and orchestration module 102B) can query the country-specific career data store based on the country identifier “United States” to retrieve the career record and identify “information technology specialist” as a candidate career compatible with a student's extracted post-secondary aspiration of “pursue a career in technology.”

The data repository 108 may store an accommodation knowledge base that comprises a plurality of accommodation records each associated with at least one disability type, which can be retrieved by the accommodation agent (a part of the AI recommendation and orchestration module 102B) to match disability-related support needs to candidate accommodations. For example, the data repository 108 can store an accommodation record associated with the disability type “dyslexia” that includes candidate accommodations such as “text-to-speech software for reading-intensive tasks,” “extended time for written assignments,” or “audiobook versions of textbooks,” such that the accommodation (a part of the AI recommendation and orchestration module 102B) can retrieve the accommodation record in response to processing a state object representation that includes a disability-related support need of “requires assistive technology for reading assignments” and can select “text-to-speech software for reading-intensive tasks” as a candidate accommodation.

In some implementations, the data repository 108 further maintains a plurality of specialized knowledge bases implemented as vector databases, including at least a college knowledge base, an occupation knowledge base, and a training program knowledge base. Each knowledge base may contain structured records describing programs or occupations and associated metadata such as location, delivery format, admission criteria, and disability support attributes. The records are embedded into a vector space using an embedding model, and the resulting vectors and metadata persist in a vector store.

When the career matching agent or goal planning agent seeks to identify relevant programs or occupations, the agent constructs a query derived from the state object representation and performs query expansion using a language model. For instance, a user interest expressed as “digital 3D tools” may be expanded into a query including “3D modeling,” “computer-aided design,” and “animation software.” The expanded query is embedded and used to retrieve a set of candidate records from one or more of the knowledge bases via semantic similarity search.

A hybrid relevance scoring algorithm may be applied to each candidate's record. In one example implementation, the total relevance score is computed as a weighted combination of: (i) a semantic similarity score between the query embedding and the record embedding (for example, weighted at 30%), (ii) a keyword matching score based on overlap between the expanded query and textual fields of the record (for example, weighted at 25%), (iii) a location preference score reflecting alignment between user location preferences from the user context data and location metadata in the record (for example, weighted at 20%), and (iv) a program attribute score capturing the presence or level of disability support features indicated in the record (for example, weighted at 25%). The system may discard any candidate record for which the total relevance score falls below a configured minimum threshold (for example, 0.25) and may sort remaining records by relevance score before storing them as candidate careers or programs in the state object representation.

In certain implementations, the data repository 108 and associated services are configured for regulatory compliance scenarios, such as environments subject to FERPA or HIPAA. Sensitive data fields, including personally identifiable information and disability descriptors, may be encrypted at rest using encryption keys managed by a key management service that automatically rotates keys at predetermined intervals. The transition plan recommendation system 102 may employ envelope encryption, in which per-record data keys are encrypted with a master key and the master key is periodically rotated by the key management service. Network communications that carry such data between the transition plan recommendation system 102, the data repository 108, and the machine learning model 110 are protected using transport-layer security protocols, and in some embodiments, application-level encryption is applied to selected fields before storage so that the underlying data remains protected even if storage-level encryption is bypassed.

The system environment 100 can include a machine learning model 110. The machine learning model 110 can be a trained artificial intelligence model that executes feature extraction operations, transition goal generation operations, career matching operations, or accommodation recommendation operations based on user-specific educational records and user context data received via the network 101. For example, the machine learning model 110 can receive an individualized education program document that includes a statement indicating the student aspires to pursue a career in culinary arts, a progress report documenting the student's reading level at a ninth-grade equivalent, and teacher notes describing the student's need for text-to-speech software for written assignments, and can extract a post-secondary aspiration such as “pursue a career in culinary arts,” an academic performance indicator such as “reading level at ninth-grade equivalent,” and a disability-related support need such as “requires text-to-speech software for written assignments.”

In some implementations, the machine learning model 110 can be a natural language processing model comprising one or more transformer layers and one or more convolutional layers or can be a generative artificial intelligence model that generates transition goals formatted as measurable objectives. For example, the machine learning model 110 can generate a transition goal formatted as “By June 2026, the student will complete a vocational cooking course at a community college as measured by course completion certificate.” The machine learning model 110 can determine one or more candidate careers by applying at least one machine learning technique selected from a classification model that predicts likely career paths from labeled training data, a clustering model that groups users according to similarity metrics, a collaborative filtering model that recommends careers selected by users with similar state object representations, or a reinforcement learning model that updates career recommendations based on feedback from counselors. For example, the machine learning model 110 can apply a classification model trained on historical datasets that include individualized education programs, assessments, and records of student strengths, interests, limitations, and eventual career placements to predict that a student profile indicating an interest in technology and mild cognitive challenges is compatible with candidate careers such as “information technology specialist” or “graphic designer.” The machine learning model 110 may be updated based on iterative feedback comprising confirmation or rejection of at least one of the plurality of transition goals by an authorized reviewer, such that recommendation accuracy improves over time. The updating may include retraining the model on augmented training datasets that incorporate labeled examples of successful and unsuccessful transition plans, or fine-tuning model parameters using gradient descent optimization algorithms that minimize a loss function measuring the difference between predicted career matches and counselor-validated career matches.

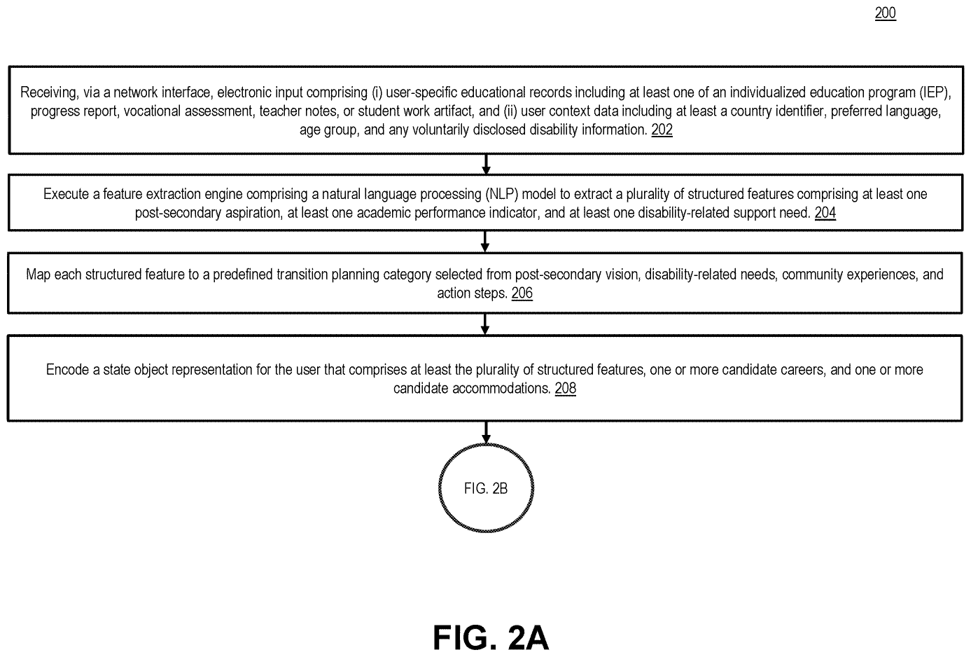

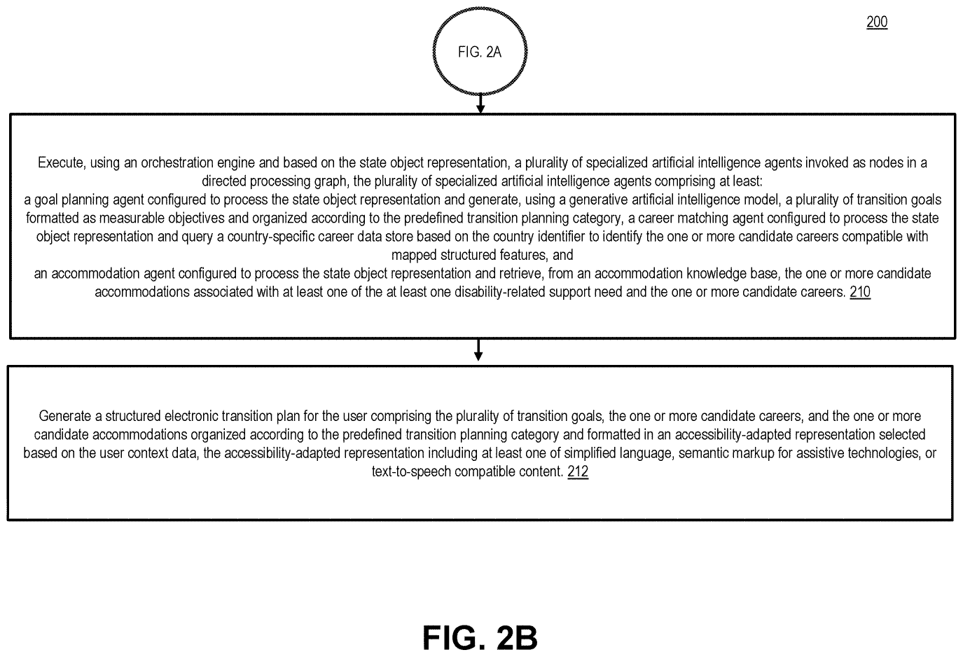

Referring now to FIG. 2A, illustrated is a flow diagram of a method 200 for generating a structured user state for transition planning based on educational records and user context data. The method 200 can be executed, performed, or otherwise carried out by any of the computing systems or devices described herein. In brief overview of the method 200, the method 200 can include receiving electronic input comprising educational records and user context data (the step 202), executing a natural language processing model to extract structured features (the step 204), mapping each structured feature to a transition planning category (the step 206), and encoding a state object representation for the user (the step 208).

The method 200 can include receiving electronic input comprising educational records and user context data (the step 202). In some embodiments, the electronic input can be received by the transition plan recommendation system 102. The transition plan recommendation system 102 can receive the electronic input via a network interface that couples one or more user devices 104A-104C to the transition plan recommendation system 102 over a network 101 such as the Internet or a local area network. In some implementations, the electronic input can include user-specific educational records comprising at least one of an individualized education program, progress report, vocational assessment, teacher notes, or student work artifact. For example, the transition plan recommendation system 102 can receive an individualized education program document uploaded by an educator via a web-based interface hosted by the user interface and data ingestion module 102A, a progress report in portable document format transmitted from a user device 104A over the network 101, a vocational assessment spreadsheet submitted through a file upload form rendered on a user device 104B, teacher notes in word processing document format provided by a special education coordinator operating a user device 104C, or a student work artifact such as a digital portfolio image captured via a mobile application executing on a user device 104A and transmitted to the transition plan recommendation system 102 for storage in the data repository 108.

The electronic input can include user context data comprising at least a country identifier, preferred language, age group, and any voluntarily disclosed disability information. For example, the user context data can include a country identifier such as “United States,” “Saudi Arabia,” or “Kuwait,” a preferred language such as “English” or “Arabic,” an age group such as “K-12” or “adult,” and voluntarily disclosed disability information such as “autism spectrum disorder,” “dyslexia,” or “mobility impairment.” The transition plan recommendation system 102 can receive the electronic input in response to user interaction with a graphical user interface element such as a file upload button or a document submission form. In some implementations, the electronic input can be received after an educator or parent completes a multi-step form that prompts for the country identifier, preferred language, age group, and voluntarily disclosed disability information prior to document upload.

For example, the user interface and data ingestion module 102A can present a first form page requesting the country identifier and preferred language, a second form page requesting the age group and voluntarily disclosed disability information, and a third form page providing file upload controls for the user-specific educational records, such that the transition plan recommendation system 102 receives the user context data prior to receiving the user-specific educational records. The received electronic input may include scanned documents or images captured via a mobile or tablet application, which can be processed using optical character recognition to convert handwritten or printed text into machine-readable text. For example, the user interface and data ingestion module 102A can receive a scanned teacher note containing handwritten observations regarding a student's academic strengths and behavioral patterns, and the transition plan recommendation system 102 can apply an optical character recognition engine to convert the handwritten text into a machine-readable text string such as “Student demonstrates strong verbal communication skills but requires additional assistance for written assignments,” which can be transmitted to the AI recommendation and orchestration module 102B for downstream feature extraction operations.

In some implementations, prior to or in addition to receiving uploaded educational records, the user interface and data ingestion module 102A initiates an interactive discovery phase implemented as a chatbot-guided interview. During this Transition Planning Conversation (TPC) interview, a conversational agent presents a sequence of short, targeted prompts organized into defined segments such as student information, disability and support needs, hobbies and interests, personal strengths, and education or work intentions. The prompts may be rendered with supportive messaging and visual elements to maintain engagement and may be dynamically adapted based on prior responses and values stored in the state object representation. The conversational agent can update the state object in real time with both raw responses and derived preferences inferred by an underlying language model.

In some embodiments, as the AI recommendation and orchestration module 102B generates candidate careers, educational programs, or transition goals, the conversational agent explains portions of the underlying decision process to the user. For example, the agent may present a candidate career with a numerical or qualitative matching score (e.g., “82% match based on your interest in 3D tools, your preferred location, and programs that offer disability support services”) and may solicit additional input to refine preferences (e.g., “Would you prefer more hands-on training or more classroom learning?”). These interactive explanations allow the system to guide the user through the transition planning process rather than merely presenting static outputs derived from uploaded forms.

The method 200 can include executing a natural language processing model to extract structured features (the step 204). The natural language processing model can be executed by the transition plan recommendation system 102. The transition plan recommendation system 102 can execute the natural language processing model to extract a plurality of structured features comprising at least one post-secondary aspiration, at least one academic performance indicator, and at least one disability-related support need from the user-specific educational records received in the step 202.

The extraction operations can be performed by applying one or more transformer layers to tokenized representations of the machine-readable text to identify contextually relevant portions of the text, and by applying one or more convolutional layers to detect patterns associated with predefined entity types such as post-secondary aspiration, academic performance indicator, or disability-related support need. For example, the natural language processing model can extract a post-secondary aspiration such as “attend community college for information technology certification,” an academic performance indicator such as “reading level at ninth grade equivalent,” and a disability-related support need such as “requires assistive technology for written assignments” from an individualized education program document that includes statements such as “student expresses interest in pursuing IT certification after graduation,” “student currently reads at a ninth grade level according to standardized assessments,” and “student benefits from text-to-speech software when completing reading-intensive tasks.”

In some implementations, the transition plan recommendation system 102 can execute the natural language processing model after applying an optical character recognition engine to convert scanned documents or handwritten materials into machine-readable text. For example, the transition plan recommendation system 102 can receive a scanned teacher note containing handwritten observations regarding a student's academic strengths and behavioral patterns, apply the optical character recognition engine to convert the handwritten text into a machine-readable text string such as “student demonstrates strong verbal communication skills but requires additional assistance for written assignments,” and execute the natural language processing model to extract a disability-related support need such as “requires additional assistance for written assignments” from the machine-readable text string. The extraction operations may include tokenizing the machine-readable text into individual words or sub-word units, applying attention mechanisms implemented by the one or more transformer layers to assign weights to tokens based on relevance to the predefined entity types, and classifying tokens according to entity labels such as post-secondary aspiration, academic performance indicator, or disability-related support need based on the assigned weights and learned patterns from training data.

The method 200 can include mapping each structured feature to a transition planning category (the step 206). The structured features can be mapped by the transition plan recommendation system 102. The transition plan recommendation system 102 can map each structured feature extracted in the step 204 to a predefined transition planning category selected from post-secondary vision, disability-related needs, community experiences, and action steps. For example, the transition plan recommendation system 102 can map a post-secondary aspiration such as “attend community college for information technology certification” to the post-secondary vision category, can map an academic performance indicator such as “reading level at ninth grade equivalent” to the action steps category to inform instructional coursework planning, and can map a disability-related support need such as “requires assistive technology for written assignments” to the disability-related needs category.

The transition plan recommendation system 102 can map the structured features in response to executing the natural language processing model to extract the plurality of structured features in the step 204. In some implementations, the transition plan recommendation system 102 can map the structured features after consolidating the structured features from multiple user-specific educational records to generate a comprehensive profile of the student's educational progress, strengths, and aspirations. For example, the transition plan recommendation system 102 can receive a first individualized education program document that includes a post-secondary aspiration of “pursue employment in culinary arts,” a second progress report that documents an academic performance indicator of “demonstrates proficiency in following multi-step instructions,” and a third vocational assessment that identifies a disability-related support need of “benefits from visual schedules for task sequencing,” and can consolidate the three structured features into a unified state object representation prior to mapping each feature to the predefined transition planning categories. The transition plan recommendation system 102 can map the structured features by applying rule-based classification logic that associates extracted entities with predefined transition planning categories based on keyword matching, semantic similarity, or machine learning-based classification.

For example, the transition plan recommendation system 102 can apply a keyword matching rule that maps any structured feature containing terms such as “attend,” “enroll,” or “pursue” to the post-secondary vision category, or can apply a semantic similarity algorithm that compares vector representations of extracted features to stored exemplar vectors for each transition planning category and assigns each feature to the category with the highest cosine similarity score. The mapping operations may include querying a lookup table stored in the data repository 108 that associates specific entity types such as “post-secondary aspiration,” “academic performance indicator,” or “disability-related support need” with corresponding transition planning categories such as post-secondary vision, action steps, or disability-related needs, or may include executing a machine learning classifier trained on labeled training data comprising historical examples of structured features extracted from user-specific educational records and their manually assigned transition planning categories by special education professionals.

The method 200 can include encoding a state object representation for the user (the step 208). The state object representation can be encoded by the transition plan recommendation system 102. The transition plan recommendation system 102 can encode a state object representation for the user that comprises at least the plurality of structured features, one or more candidate careers, and one or more candidate accommodations. For example, the state object representation can include structured features such as “post-secondary aspiration: attend community college for information technology certification,” “academic performance indicator: reading level at ninth-grade equivalent,” and “disability-related support need: requires text-to-speech software for written assignments,” along with candidate careers such as “information technology specialist” or “graphic designer,” and candidate accommodations such as “text-to-speech software for reading-intensive tasks” or “extended time for written assignments.” The transition plan recommendation system 102 can encode the state object representation in response to mapping each structured feature to a predefined transition planning category in the step 206.

In some implementations, the transition plan recommendation system 102 can encode the state object representation after the career matching agent 102B queries a country-specific career data store based on the country identifier to identify the one or more candidate careers compatible with mapped structured features, and after the accommodation agent 102B retrieves the one or more candidate accommodations from an accommodation knowledge base. For example, the career matching agent 102B can query a career data store for the United States that includes a career record for “information technology specialist” with a Standard Occupational Classification code of 15-1251, a median annual wage of $97,430, and a job growth projection of 13 percent from 2020 to 2030, such that the career matching agent 102B can identify “information technology specialist” as a candidate career compatible with the extracted post-secondary aspiration of “attend community college for information technology certification,” and the accommodation agent 102B can retrieve an accommodation record associated with the disability type “dyslexia” that includes candidate accommodations such as “text-to-speech software for reading-intensive tasks” or “extended time for written assignments,” such that the accommodation agent 102B can select “text-to-speech software for reading-intensive tasks” as a candidate accommodation associated with the disability-related support need of “requires text-to-speech software for written assignments.”

The transition plan recommendation system 102 can encode the state object representation by serializing the plurality of structured features, the one or more candidate careers, and the one or more candidate accommodations into a structured data format such as JavaScript Object Notation or Extensible Markup Language. The encoding operations may include assigning unique identifiers to each structured feature, candidate career, and candidate accommodation. For example, the transition plan recommendation system 102 can assign a unique identifier such as “feature 001” to the structured feature “post-secondary aspiration: attend community college for information technology certification,” can assign a unique identifier such as “career_001” to the candidate career “information technology specialist,” and can assign a unique identifier such as “accommodation 001” to the candidate accommodation “text-to-speech software for reading-intensive tasks.”

The encoding operations may include organizing the data elements according to the predefined transition planning categories. For example, the transition plan recommendation system 102 can organize the structured feature “post-secondary aspiration: attend community college for information technology certification” under the post-secondary vision category, can organize the structured feature “academic performance indicator: reading level at ninth-grade equivalent” under the action steps category, and can organize the structured feature “disability-related support need: requires text-to-speech software for written assignments” under the disability-related needs category. The encoding operations may include appending metadata such as timestamps, user identifiers, or session identifiers to facilitate state persistence and conversation resume operations. For example, the transition plan recommendation system 102 can append a timestamp such as “2026-03-15T14:30:00Z” to indicate the time at which the state object representation was encoded, can append a user identifier such as “user_12345” to associate the state object representation with a particular user, and can append a session identifier such as “session_67890” to associate the state object representation with a particular interaction session, such that the transition plan recommendation system 102 can store the state object representation in the data repository 108 and can retrieve the state object representation at a later time to resume transition plan generation operations in response to an interruption.

Referring now to FIG. 2B, illustrated is a flow diagram of a method 200 for generating specialized-agent outputs and customizing an accessibility-adapted electronic transition plan. The method 200 can be executed, performed, or otherwise carried out by any of the computing systems or devices described herein. In brief overview of the method 200, the method 200 can include executing specialized artificial intelligence agents as nodes in a directed processing graph (the step 210) and generating a customized structured electronic transition plan for the user (the step 212).

The method 200 can include executing specialized artificial intelligence agents as nodes in a directed processing graph (the step 210). The specialized artificial intelligence agents can be executed by the transition plan recommendation system 102. The transition plan recommendation system 102 can execute, based on the state object representation encoded in the step 208, a plurality of specialized artificial intelligence agents as nodes in a directed processing graph, the plurality of specialized artificial intelligence agents comprising at least a goal planning agent, a career matching agent, and an accommodation agent.

The goal planning agent can process the state object representation and generate, using a generative artificial intelligence model comprising one or more transformer layers and one or more convolutional layers, a plurality of transition goals formatted as measurable objectives and organized according to the predefined transition planning category. For example, the goal planning agent can receive a state object representation that includes a post-secondary aspiration such as “pursue employment in information technology,” an academic performance indicator such as “demonstrates proficiency in following multi-step instructions,” and a disability-related support need such as “requires assistive technology for reading assignments,” and can generate a transition goal such as “By June 2026, the student will complete three career cluster explorations in technology-related fields as measured by submission of reflection documents for each exploration.” The career matching agent can process the state object representation and query a country-specific career data store based on the country identifier to identify the one or more candidate careers compatible with mapped structured features.

For example, the career matching agent can query a career data store for the United States that includes a career record for “information technology specialist” with a Standard Occupational Classification code of 15-1251, a median annual wage of $97,430, and a job growth projection of 13 percent from 2020 to 2030, and can identify “information technology specialist” as a candidate career compatible with the extracted post-secondary aspiration of “pursue employment in information technology.” The accommodation agent can process the state object representation and retrieve, from an accommodation knowledge base, the one or more candidate accommodations associated with at least one of the at least one disability-related support need and the one or more candidate careers. For example, the accommodation agent can retrieve an accommodation record associated with the disability type “dyslexia” that includes candidate accommodations such as “text-to-speech software for reading-intensive tasks,” “extended time for written assignments,” or “audiobook versions of technical documentation,” and can select “text-to-speech software for reading-intensive tasks” as a candidate accommodation associated with the disability-related support need of “requires assistive technology for reading assignments” and the candidate career of “information technology specialist.”

The transition plan recommendation system 102 can execute the plurality of specialized artificial intelligence agents in response to encoding the state object representation in the step 208 of FIG. 2A. In some implementations, the transition plan recommendation system 102 can execute the plurality of specialized artificial intelligence agents after validating the state object representation to confirm the presence of required data elements such as post-secondary aspirations, academic performance indicators, and disability-related support needs. The transition plan recommendation system 102 can execute the plurality of specialized artificial intelligence agents by invoking each agent sequentially or in parallel according to a directed processing graph that defines dependencies and execution order among the agents. For example, the career matching agent may execute after the goal planning agent completes aligning candidate careers with generated transition goals, or the accommodation agent may execute concurrently with the career matching agent to retrieve candidate accommodations while career data store queries are being processed. The execution operations may include transmitting the state object representation as input to each specialized artificial intelligence agent, receiving structured outputs comprising transition goals, candidate careers, or candidate accommodations from each agent, and updating the state object representation to incorporate the structured outputs for downstream processing by the transition plan generation and localization module 102C.

In some implementations of the step 210, executing specialized artificial intelligence agents as nodes in the directed processing graph comprises invoking a plurality of different agents that each perform a distinct computational role while operating over the same state object representation. The directed processing graph may define dependencies and routing conditions among the agents such that the output of one agent becomes part of the state object representation consumed by downstream agents. For example, the directed processing graph may include at least a goal planning agent, a career matching agent, an accommodation agent, a conversational routing agent, a skills assessment agent, a knowledge retrieval agent, and a translation agent, each represented as a node in the graph.

In one embodiment, the conversational routing agent operates as an entry point for the directed processing graph at step 210. The conversational routing agent can inspect the state object representation, including any conversation history and user profile data, and determine which specialized artificial intelligence agent to invoke next based on routing rules encoded in the directed processing graph. For instance, when the state object representation indicates that structured features have been extracted but no transition goals have yet been generated, the conversational routing agent may select the goal planning agent as the next node in the graph. When the state object representation indicates that an initial set of transition goals exists, but no candidate careers have been identified, the conversational routing agent may route execution to the career matching agent. The goal planning agent, when invoked during the step 210, can read the state object representation, including mapped transition planning categories and any skills information, and generate or update a plurality of transition goals. The goal planning agent may call a generative artificial intelligence model with prompts and constraints that enforce measurable, time-bounded objectives, and then write the generated transition goals back into the state object representation with references to the transition planning categories. The career matching agent, when invoked, can read the state object representation to obtain post-secondary aspirations, interests, location preferences, and disability-related support needs, and can query one or more knowledge bases to identify candidate careers and educational or training programs that are compatible with those attributes. The accommodation agent can then read both disability-related support needs and candidate careers from the state object representation and retrieve one or more candidate accommodations from an accommodation knowledge base, optionally computing an accommodation feasibility score for each candidate career.

In some implementations, the skills assessment agent is also invoked as part of the step 210. The skills assessment agent can generate interactive assessment items, receive user responses through the user interface, and update the state object representation with inferred skill levels and identified skill gaps relative to target careers or transition goals. These skill levels and gap indicators may subsequently be consumed by the goal planning agent to refine transition goals or by the career matching agent to filter or prioritize candidate careers. The knowledge retrieval agent, when invoked, can perform retrieval-augmented generation by executing semantic search queries over curated document corpora, retrieving factual passages concerning at least one of regulatory requirements, program descriptions, or local service providers, and providing the retrieved passages as conditioning context to a language model used by the goal planning agent, the career matching agent, or the accommodation agent.

The translation agent may be invoked either after one or more other agents have produced textual outputs or interleaved within the directed processing graph, and can transform internal, canonical-language representations of goals, career descriptions, and accommodations into localized textual content in the preferred language specified in the user context data. In some embodiments, after each agent invocation, the transition plan recommendation system 102 updates the state object representation to include any new goals, candidate careers, candidate accommodations, skill assessments, or retrieved factual information, and records metadata such as the identifier of the agent that produced the updates and a timestamp of execution. By iteratively invoking different specialized artificial intelligence agents according to the directed processing graph and updating the shared state object representation, the step 210 constructs a comprehensive, machine-readable representation of the user's transition goals, career options, accommodations, skills, and relevant contextual information.

As an illustrative example of the step 210, consider a state object representation that, after completion of the step 208, includes a post-secondary aspiration of “attend community college for information technology certification,” an academic performance indicator of “reading level at ninth-grade equivalent,” a disability-related support need of “requires text-to-speech software for written assignments,” and a country identifier of “United States.” In this example, the conversational routing agent first selects the skills assessment agent to present a short series of questions about the student's comfort with troubleshooting hardware, writing code, and working in teams. The skills assessment agent updates the state object representation to indicate strong hardware troubleshooting skills and moderate comfort with team collaboration.

The conversational routing agent then invokes the goal planning agent, which generates a transition goal such as “By June 2026, the student will complete three technology-related career exploration activities and one introductory programming course, as measured by completion certificates and reflection summaries,” and writes that goal into the state object representation. Next, the conversational routing agent invokes the career matching agent, which constructs an expanded query from the student's interests and the generated goal, retrieves candidate information technology careers from a knowledge base, computes hybrid relevance scores for the candidates, and writes the top-ranked careers, such as “information technology support specialist” and “network technician,” into the state object representation. Finally, the conversational routing agent invokes the accommodation agent, which reads the disability-related support need and the candidate careers and selects accommodations such as “text-to-speech software for technical documentation” and “extended time for written troubleshooting reports” from the accommodation knowledge base, storing them with associated feasibility scores in the state object representation. The resulting state object representation, enriched by the outputs of multiple agents, is then used in the step 212 to generate the structured electronic transition plan.

The method 200 can include generated a customized structured electronic transition plan for the user (the step 212). The structured electronic transition plan can be customized by the transition plan recommendation system 102. The transition plan recommendation system 102 can customize a structured electronic transition plan for the user comprising the plurality of transition goals, the one or more candidate careers, and the one or more candidate accommodations organized according to the predefined transition planning category and formatted in an accessibility-adapted representation selected based on the user context data, the accessibility-adapted representation including at least one of simplified language, semantic markup for assistive technologies, or text-to-speech compatible content.

For example, the transition plan recommendation system 102 can customize a structured electronic transition plan that includes a post-secondary vision section stating “The student aspires to attend a community college information technology certification program,” a disability-related needs section stating “The student requires text-to-speech software and extended time for reading-intensive coursework,” a community experiences section stating “The student will participate in a volunteer technology support program at a local library to develop practical IT skills,” and an action plan section stating “The student will complete one career exploration activity per quarter, meet with a vocational counselor bimonthly, and submit a resume draft by March 2026,” where the entire plan is formatted with semantic markup for screen readers, uses simplified language appropriate for a ninth-grade reading level, and includes text-to-speech compatible content that can be rendered via assistive technologies.

The transition plan recommendation system 102 can customize the structured electronic transition plan in response to executing the plurality of specialized artificial intelligence agents in the step 210. In some implementations, the transition plan recommendation system 102 can customize the structured electronic transition plan after receiving confirmation from a human reviewer that the generated transition goals, candidate careers, and candidate accommodations are appropriate and compliant with federal and state regulations. The transition plan recommendation system 102 can customize the structured electronic transition plan by selecting at least one accessibility parameter from a group consisting of font size, contrast mode, text complexity level, and text-to-speech playback speed, and generating the accessibility-adapted representation according to the at least one selected accessibility parameter based on the user context data.

For example, a user who voluntarily disclosed visual impairment can receive a plan formatted with high-contrast text and screen reader-optimized semantic tags, or a user who indicated cognitive disability can receive a plan with simplified language and visual cues to aid comprehension. The customization operations may include organizing the plurality of transition goals, the one or more candidate careers, and the one or more candidate accommodations into structured sections corresponding to the predefined transition planning categories. The customization operations may include applying formatting rules that adapt the presentation of text content based on voluntarily disclosed disability information. The customization operations may include generating multiple export formats comprising at least one of portable document format, word processing document format, or hypertext markup language format to facilitate distribution to educators, parents, or administrators and integration with school individualized education program management systems.

### Non-Limiting Example

As a non-limiting example of the method 200, consider a student who is enrolled in a United States high school, has an existing individualized education program (IEP), and has been identified as having a specific learning disability affecting reading and an interest in technology-related careers. An educator operating a user device 104A launches a web-based interface provided by the user interface and data ingestion module 102A and initiates a new transition planning session. At the step 202, the educator uploads (i) a current IEP document in portable document format, (ii) the most recent progress report as a scanned image, (iii) a vocational assessment spreadsheet indicating the student's interest in “computers and digital 3D tools,” and (iv) teacher notes in word processing format describing the student's classroom performance. The educator also enters user context data specifying that the country identifier is “United States,” the preferred language is “English,” the age group is “K-12,” and voluntarily disclosed disability information includes “specific learning disability (reading)” and “emotional disturbance (mild anxiety).”

The user interface and data ingestion module 102A transmits the electronic input to the transition plan recommendation system 102. For the scanned progress report and any handwritten notes, the system applies an optical character recognition engine to convert the image content into machine-readable text. At the step 204, the AI recommendation and orchestration module 102B executes the natural language processing model 110 on the machine-readable text of the IEP, progress report, vocational assessment, and teacher notes. The natural language processing model identifies and extracts structured features including (i) a post-secondary aspiration such as “attend community college to obtain information technology certification,” (ii) academic performance indicators such as “reading level at ninth-grade equivalent” and “performs above grade level in hands-on technology projects,” and (iii) disability-related support needs such as “requires text-to-speech software for reading-intensive coursework” and “benefits from predictable routines to reduce anxiety.” At the step 206, the transition plan recommendation system 102 maps these structured features into transition planning categories so that, for example, the post-secondary aspiration is mapped to the post-secondary vision category, the reading level indicator is mapped to action steps, and the assistive technology and routine-related needs are mapped to the disability-related needs category.

In parallel with document ingestion, the system initiates an interactive discovery phase via a chatbot-guided Transition Planning Conversation (TPC) interview, as described above. Using the user interface and data ingestion module 102A, a conversational agent presents short, engaging prompts in segments covering student information, disability and support needs, hobbies and interests, personal strengths, and education or work intentions. The student answers questions such as “What do you like to do in your free time?” (answer: “build and fix computers,” “play 3D games”), “What is hard for you at school?” (answer: “long reading assignments,” “remembering multi-step instructions”), and “How do teachers help you best?” (answer: “checklists,” “extra time,” “reading out loud”). The conversational agent updates the emerging state object representation in real time with these responses and uses a language model to infer preferences such as “hands-on learning preferred,” “interest in hardware troubleshooting,” and “benefits from visual checklists.”

At the step 208, the transition plan recommendation system 102 encodes a state object representation for the student that includes at least: (i) the mapped structured features from the educational records, (ii) the conversationally derived preferences and strengths, (iii) preliminary candidate careers, and (iv) any candidate accommodations already inferred from the documents or the chatbot interaction. Because the user context data indicates that the student's disability categories include specific learning disability and emotional disturbance, the AI recommendation and orchestration module 102B applies the “Disability Filter=Success Filter” principle. A conversational sub-agent presents conditional follow-up questions tailored to these categories, such as “Do loud or busy environments make it harder to concentrate?” and “Do you find it difficult to get started on long assignments?” The responses (e.g., “yes, noisy classrooms are hard,” “yes, I need help breaking things into steps”) are parsed and added to the state object as nuanced needs such as “noise sensitivity” and “difficulty initiating multi-step tasks.” The module then consults a disability-skills matrix that maps combinations of [specific learning disability, difficulty initiating multi-step tasks] and [emotional disturbance, noise sensitivity] to specific annual transition activities (for example, “practice using visual checklists to start assignments,” “participate in a gradually more complex set of structured work experiences in quieter environments”), key supports (“provide visual task sequences,” “access to a quiet workspace”), and recommended services (“executive functioning coaching,” “counseling check-ins”), and stores these outputs in the state object for subsequent use by the goal planning and accommodation agents.

At the step 210, the transition plan recommendation system 102 executes a plurality of specialized artificial intelligence agents as nodes in the directed processing graph based on the state object representation. First, a skills assessment agent reviews the state object and, if needed, presents a brief skills quiz to the student about troubleshooting hardware, basic scripting, and teamwork; the resulting skill levels and gaps are added to the state object. A goal planning agent then processes the state object and uses a generative AI model to generate transition goals such as “By June 2026, the student will complete three technology-related career exploration activities and one introductory computer hardware course, as measured by completion certificates and reflection summaries,” and “By March 2026, the student will independently use a visual checklist to initiate and complete multi-step assignments in 4 out of 5 opportunities.” These goals are tagged under post-secondary vision, action steps, and disability-related needs. Next, a career matching agent constructs a query from the student's interests (“computers,” “digital 3D tools”), preferences (“hands-on learning,” “quiet environments”), and location, and uses query expansion to include related terms such as “3D modeling,” “computer support specialist,” and “IT technician.” It queries college, occupation, and training vector knowledge bases, computes a hybrid relevance score for each candidate program based on semantic similarity, keyword matches, location preference, and presence of disability support attributes, filters out candidates below a 0.25 threshold, and writes the top-ranked careers and programs (e.g., “Information Technology Support Specialist certificate program at Local Community College”) into the state object.

The accommodation agent then reads the disability-related support needs, nuanced needs from the disability-skills matrix, and candidate careers from the state object, queries an accommodation knowledge base for accommodations associated with specific learning disability and anxiety in the context of IT training, and selects accommodations such as “text-to-speech software for technical documentation,” “extended time for written troubleshooting reports,” “use of noise-reducing headphones in lab environments,” and “visual task breakdowns for complex troubleshooting workflows.” These are written back into the state object, optionally with feasibility scores relative to each candidate program. During this process, a guardrail enforcement engine inspects inputs and outputs for personally identifiable information, replaces prohibited disability-related phrases with preferred person-first alternatives, and ensures that all generated content is age-appropriate for a high-school student. Simultaneously, via a WebSocket connection between the server 106 and the user device 104A, the system streams progress messages such as “Starting skills assessment agent,” “Generated 2 transition goals,” and “Identified 5 IT programs with strong disability support,” so the educator and student can see the system's internal progress in real time.

At the step 212, the transition plan generation and localization module 102C reads the enriched state object and constructs a structured electronic transition plan for the student. The plan includes a post-secondary vision section describing the student's goal of attending a community college IT certification program, a disability-related needs section detailing the reading and anxiety-related needs and corresponding supports, a community experiences section describing activities such as volunteering at a local library IT help desk, and an action plan section listing specific annual goals, intermediate milestones, and responsible parties. Based on the user context data indicating a K-12 student with reading challenges, the module formats the plan using simplified language, a ninth-grade reading level, semantic markup compatible with screen readers, and text-to-speech compatible content. The plan is exported as both a PDF and an HTML document and transmitted over the network 101 back to the educator's device 104A. The educator can review and optionally edit the generated plan, and once confirmed, the plan can be stored in the data repository 108 as part of the student's official transition documentation and used as training data for future model refinement.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of this disclosure or the claims.

Embodiments implemented in computer software may be implemented in software, firmware, middleware, microcode, hardware description languages, or any combination thereof. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting the claimed features or this disclosure. Thus, the operation and behavior of the systems and methods were described without reference to the specific software code being understood that software and control hardware can be designed to implement the systems and methods based on the description herein.

When implemented in software, the functions may be stored as one or more instructions or code on a non-transitory computer-readable or processor-readable storage medium. The steps of a method or algorithm disclosed herein may be embodied in a processor-executable software module, which may reside on a computer-readable or processor-readable storage medium. A non-transitory computer-readable or processor-readable media includes both computer storage media and tangible storage media that facilitate transfer of a computer program from one place to another. A non-transitory processor-readable storage media may be any available media that may be accessed by a computer. By way of example, and not limitation, such non-transitory processor-readable media may comprise RAM, ROM, EEPROM, CD-ROM or other optical disk storage, magnetic disk storage or other magnetic storage devices, or any other tangible storage medium that may be used to store desired program code in the form of instructions or data structures and that may be accessed by a computer or processor. Disk and disc, as used herein, include compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the embodiments described herein and variations thereof. Various modifications to these embodiments will be readily apparent to those skilled in the art, and the principles defined herein may be applied to other embodiments without departing from the spirit or scope of the subject matter disclosed herein. Thus, the present disclosure is not intended to be limited to the embodiments shown herein but is to be accorded the widest scope consistent with the following claims and the principles and novel features disclosed herein.

While various aspects and embodiments have been disclosed, other aspects and embodiments are contemplated. The various aspects and embodiments disclosed are for purposes of illustration and are not intended to be limiting, with the true scope and spirit being indicated by the following claims.

What is claimed is:

1. A method for generating a disability-customized transition plan from electronic documents for a user, the method comprising:
receiving, by one or more processors via a network interface, electronic input comprising (i) user-specific educational records including at least one of an individualized education program (IEP), progress report, vocational assessment, teacher notes, or student work artifact, and (ii) user context data including at least a country identifier, preferred language, age group, and any voluntarily disclosed disability information;
executing, by the one or more processors, a feature extraction engine comprising a natural language processing (NLP) model to extract a plurality of structured features comprising at least one post-secondary aspiration, at least one academic performance indicator, and at least one disability-related support need;
mapping, by the one or more processors, each structured feature to a predefined transition planning category selected from post-secondary vision, disability-related needs, community experiences, and action steps;
encoding, by the one or more processors, a machine-readable state object representation for the user that comprises at least the plurality of structured features, one or more candidate careers, and one or more candidate accommodations;
executing, by the one or more processors using an orchestration engine and based on the machine-readable state object representation, a plurality of specialized artificial intelligence agents invoked as nodes in a directed processing graph, the plurality of specialized artificial intelligence agents comprising at least:
a goal planning agent configured to process the machine-readable state object representation and generate, using a generative artificial intelligence model, a plurality of transition goals formatted as measurable objectives and organized according to the predefined transition planning category,
a career matching agent configured to process the machine-readable state object representation and query a country-specific career data store based on the country identifier to identify the one or more candidate careers compatible with mapped structured features, and
an accommodation agent configured to process the machine-readable state object representation and retrieve, from an accommodation knowledge base, the one or more candidate accommodations associated with at least one of the at least one disability-related support need and the one or more candidate careers; and
generating, by the one or more processors, a structured electronic transition plan for the user comprising the plurality of transition goals, the one or more candidate careers, and the one or more candidate accommodations organized according to the predefined transition planning category and formatted in an accessibility-adapted representation selected based on the user context data, the accessibility-adapted representation including at least one of simplified language, semantic markup for assistive technologies, or text-to-speech compatible content.

2. The method of claim 1, further comprising, for each invocation of a respective specialized artificial intelligence agent:
applying, by a guardrail enforcement engine executed by the one or more processors, a set of machine-enforced safety rules to at least one of an input to and an output from the respective specialized artificial intelligence agent, the set of machine-enforced safety rules comprising at least:
detecting and redacting personally identifiable information using an entity-recognition model,
enforcing disability-sensitive language by replacing prohibited terms with preferred alternatives according to a stored lexicon and rejecting outputs that violate a sentiment-based threshold for negative framing, and
enforcing age-appropriate content constraints based on the age group in the user context data.

3. The method of claim 1, further comprising:
validating, by the one or more processors, the plurality of transition goals and the one or more candidate accommodations against a set of stored jurisdiction-specific transition planning rules selected based on the country identifier, validating comprising automatically detecting absence of at least one required transition-planning element and, in response, causing the goal planning agent to regenerate or augment at least a portion of the plurality of transition goals.

4. The method of claim 1, wherein executing the NLP model further comprises performing optical character recognition (OCR) on at least one user-specific educational record received as an image or scanned document to convert the image or scanned document into machine-readable text prior to extracting the plurality of structured features.

5. The method of claim 1, wherein encoding the state object representation for the user further comprises including, in the state object representation, at least one inferred limitation selected from a literacy challenge, numeracy challenge, or social communication need based on analysis of the user-specific educational records, and receiving, via a user interface and from a human reviewer, a confirmation or modification of the at least one inferred limitation.

6. The method of claim 1, wherein the career matching agent is further configured to determine the one or more candidate careers by applying at least one machine learning technique selected from a classification model that predicts likely career paths from labeled training data, a clustering model that groups users according to similarity metrics and selects careers associated with each group, a collaborative filtering model that recommends careers selected by users with similar state object representations, and a reinforcement learning model that updates career recommendations based on feedback from counselors.

7. The method of claim 1, wherein customizing the structured electronic transition plan further comprises selecting, by the one or more processors, at least one accessibility parameter from a group consisting of font size, contrast mode, text complexity level, and text-to-speech playback speed, and generating the accessibility-adapted representation according to the at least one selected accessibility parameter.

8. The method of claim 1, further comprising generating, by a translation module executed by the one or more processors, a localized version of the structured electronic transition plan in the preferred language, wherein generating the localized version comprises translating text content and adapting at least one career-related term based on country-specific terminology associated with the country identifier.

9. The method of claim 1, wherein the state object representation further comprises a session identifier and a conversation history, and wherein executing the plurality of specialized artificial intelligence agents as nodes in the directed processing graph comprises persisting updates to the state object representation after execution of each specialized artificial intelligence agent to enable resumption of the generation of the disability customized transition plan in response to an interruption.

10. A non-transitory computer readable medium for generating a disability-customized transition plan from electronic documents, the non-transitory computer readable medium comprising instructions, that when executed, cause at least one processor to:
receive, via a network interface, electronic input comprising (i) user-specific educational records including at least one of an individualized education program (IEP), progress report, vocational assessment, teacher notes, or student work artifact, and (ii) user context data including at least a country identifier, preferred language, age group, and any voluntarily disclosed disability information;
execute a feature extraction engine comprising a natural language processing (NLP) model to extract a plurality of structured features comprising at least one post-secondary aspiration, at least one academic performance indicator, and at least one disability-related support need;
map each structured feature to a predefined transition planning category selected from post-secondary vision, disability-related needs, community experiences, and action steps;
encode a machine-readable state object representation for the user that comprises at least the plurality of structured features, one or more candidate careers, and one or more candidate accommodations;
execute, using an orchestration engine and based on the machine-readable state object representation, a plurality of specialized artificial intelligence agents invoked as nodes in a directed processing graph, the plurality of specialized artificial intelligence agents comprising at least:
a goal planning agent configured to process the machine-readable state object representation and generate, using a generative artificial intelligence model, a plurality of transition goals formatted as measurable objectives and organized according to the predefined transition planning category,
a career matching agent configured to process the machine-readable state object representation and query a country-specific career data store based on the country identifier to identify the one or more candidate careers compatible with mapped structured features, and
an accommodation agent configured to process the machine-readable state object representation and retrieve, from an accommodation knowledge base, the one or more candidate accommodations associated with at least one of the at least one disability-related support need and the one or more candidate careers; and
generate a structured electronic transition plan for the user comprising the plurality of transition goals, the one or more candidate careers, and the one or more candidate accommodations organized according to the predefined transition planning category and formatted in an accessibility-adapted representation selected based on the user context data, the accessibility-adapted representation including at least one of simplified language, semantic markup for assistive technologies, or text-to-speech compatible content.

11. The non-transitory computer readable medium of claim 10, wherein the instructions further cause the at least one processor to:
for each invocation of a respective specialized artificial intelligence agent:
applying, by a guardrail enforcement engine executed by the one or more processors, a set of machine-enforced safety rules to at least one of an input to and an output from the respective specialized artificial intelligence agent, the set of machine-enforced safety rules comprising at least:
detecting and redacting personally identifiable information using an entity-recognition model,
enforcing disability-sensitive language by replacing prohibited terms with preferred alternatives according to a stored lexicon and rejecting outputs that violate a sentiment-based threshold for negative framing, and
enforcing age-appropriate content constraints based on the age group in the user context data.

12. The non-transitory computer readable medium of claim 10, wherein the instructions further cause the at least one processor to:
validate the plurality of transition goals and the one or more candidate accommodations against a set of stored jurisdiction-specific transition planning rules selected based on the country identifier, validating comprising automatically detecting absence of at least one required transition-planning element and, in response, causing the goal planning agent to regenerate or augment at least a portion of the plurality of transition goals.

13. The non-transitory computer readable medium of claim 10, wherein executing the NLP model further comprises performing optical character recognition (OCR) on at least one user-specific educational record received as an image or scanned document to convert the image or scanned document into machine-readable text prior to extracting the plurality of structured features.

14. The non-transitory computer readable medium of claim 10, wherein encoding the state object representation for the user further comprises including, in the state object representation, at least one inferred limitation selected from a literacy challenge, numeracy challenge, or social communication need based on analysis of the user-specific educational records, and receiving, via a user interface and from a human reviewer, a confirmation or modification of the at least one inferred limitation.

15. The non-transitory computer readable medium of claim 10, wherein the career matching agent is further configured to determine the one or more candidate careers by applying at least one machine learning technique selected from a classification model that predicts likely career paths from labeled training data, a clustering model that groups users according to similarity metrics and selects careers associated with each group, a collaborative filtering model that recommends careers selected by users with similar state object representations, and a reinforcement learning model that updates career recommendations based on feedback from counselors.

16. The non-transitory computer readable medium of claim 10, wherein customizing the structured electronic transition plan further comprises selecting, by the one or more processors, at least one accessibility parameter from a group consisting of font size, contrast mode, text complexity level, and text-to-speech playback speed, and generating the accessibility-adapted representation according to the at least one selected accessibility parameter.

17. The non-transitory computer readable medium of claim 10, wherein the instructions further cause the at least one processor to:
generate, by a translation module executed by the at least one processor, a localized version of the structured electronic transition plan in the preferred language, wherein generating the localized version comprises translating text content and adapting at least one career-related term based on country-specific terminology associated with the country identifier.

18. The non-transitory computer readable medium of claim 10, wherein the state object representation further comprises a session identifier and a conversation history, and wherein executing the plurality of specialized artificial intelligence agents as nodes in the directed processing graph comprises persisting updates to the state object representation after execution of each specialized artificial intelligence agent to enable resumption of the generation of the disability customized transition plan in response to an interruption.

19. A computer system comprising at least one processor configured to:
receive, via a network interface, electronic input comprising (i) user-specific educational records including at least one of an individualized education program (IEP), progress report, vocational assessment, teacher notes, or student work artifact, and (ii) user context data including at least a country identifier, preferred language, age group, and any voluntarily disclosed disability information;
execute a feature extraction engine comprising a natural language processing (NLP) model to extract a plurality of structured features comprising at least one post-secondary aspiration, at least one academic performance indicator, and at least one disability-related support need;
map each structured feature to a predefined transition planning category selected from post-secondary vision, disability-related needs, community experiences, and action steps;
encode a machine-readable state object representation for the user that comprises at least the plurality of structured features, one or more candidate careers, and one or more candidate accommodations;
execute, using an orchestration engine and based on the machine-readable state object representation, a plurality of specialized artificial intelligence agents invoked as nodes in a directed processing graph, the plurality of specialized artificial intelligence agents comprising at least:
a goal planning agent configured to process the machine-readable state object representation and generate, using a generative artificial intelligence model, a plurality of transition goals formatted as measurable objectives and organized according to the predefined transition planning category,
a career matching agent configured to process the machine-readable state object representation and query a country-specific career data store based on the country identifier to identify the one or more candidate careers compatible with mapped structured features, and
an accommodation agent configured to process the machine-readable state object representation and retrieve, from an accommodation knowledge base, the one or more candidate accommodations associated with at least one of the at least one disability-related support need and the one or more candidate careers; and
generate a structured electronic transition plan for the user comprising the plurality of transition goals, the one or more candidate careers, and the one or more candidate accommodations organized according to the predefined transition planning category and formatted in an accessibility-adapted representation selected based on the user context data, the accessibility-adapted representation including at least one of simplified language, semantic markup for assistive technologies, or text-to-speech compatible content.

20. The computer system of claim 19, wherein the at least one processor is further configured to, for each invocation of a respective specialized artificial intelligence agent:
applying, by a guardrail enforcement engine executed by the at least one processor, a set of machine-enforced safety rules to at least one of an input to and an output from the respective specialized artificial intelligence agent, the set of machine-enforced safety rules comprising at least:
detecting and redacting personally identifiable information using an entity-recognition model,
enforcing disability-sensitive language by replacing prohibited terms with preferred alternatives according to a stored lexicon and rejecting outputs that violate a sentiment-based threshold for negative framing, and
enforcing age-appropriate content constraints based on the age group in the user context data.
